(19) United States
(12) Patent Application Publication
(10) Pub. No.: US 2017/0367926 A1
(43) Pub. Date: Dec. 28, 2017

(54) WIRELESS STIMULATION DEVICE WITH FLEXIBLE ANTENNA

(71) Applicant: MISS VV MYSTERY INC., Dorval (CA)

(72) Inventors: Veronique VERREAULT, Montreal (CA); Martin PAYETTE, Laval (CA); Daniel THIBAULT, St-Laurent (CA)

(21) Appl. No.: 15/539,464

(22) PCT Filed: Dec. 22, 2015
(86) PCT No.: PCT/CA2015/051359

§ 371 Date: Jun. 23, 2017

Related U.S. Application Data
(60) Provisional application No. 62/095,843, filed on Dec. 23, 2014.

(51) Int. Cl. A61H 19/00; A61H 21/00; G08C 17/02

(52) U.S. Cl. CPC A61H 19/40; G08C 17/02; A61H 21/00; A61H 2201/501; A61H 2201/5097; A61H 2201/5035

(57) ABSTRACT

A stimulation device comprising a main housing comprising a vibration generator, a battery, a wireless transceiver, and at least one control circuit operatively connected to the vibration generator, the battery, and the wireless transceiver, the main housing shaped for entering a body orifice; and a flexible antenna extending from the main housing at a bottom end thereof for remaining at least partially outside the body when the main housing is inside the body, the flexible antenna operatively connected to the wireless transceiver for receiving control signals for controlling operation of the vibration generator.

### CROSS-REFERENCE TO RELATED APPLICATIONS

This application claims priority under 35 U.S.C. 119(e) of U.S. Provisional Application No. 62/095,843, filed on Dec. 23, 2014, entitled “Wireless Stimulation Device With Flexible Antenna”, which is hereby incorporated by reference in its entirety.

### TECHNICAL FIELD

The present invention relates to the field of wireless devices insertable into the body for pleasure and/or exercise.

### BACKGROUND OF THE ART

Stimulation devices may be used to help maintain a healthy and satisfying sexual relationship. They may also be used for fitness and exercise, such as pelvic floor muscle training exercises. In either case, a battery operated wireless device is inserted into an orifice of the body for stimulation of the muscles therein.

Such stimulation devices may be adapted to receive control signals from remote controllers, such as a computer or other type of control unit. However, signal reception may be hindered when the device is inserted inside the body. The device may not capture some or all of the control signals, and its intended purpose or functioning may be affected.

### SUMMARY

In accordance with a first broad aspect, there is provided a stimulation device. The stimulation device comprises a main housing comprising a vibration generator, a battery, a wireless transceiver, and at least one control circuit operatively connected to the vibration generator, the battery, and the wireless transceiver, the main housing shaped for entering a body orifice; and a flexible antenna extending from the main housing at a bottom end thereof for remaining at least partially outside the body when the main housing is inside the body, the flexible antenna operatively connected to the wireless transceiver for receiving control signals for controlling operation of the vibration generator.

In some embodiments, the main housing is shaped like a bowling pin. In some embodiments, the main housing is shaped like a pair of conjoined Faberge eggs.

In some embodiments, the antenna is covered by a molding material. In some embodiments, the main housing is covered by the molding material. In some embodiments, the molding material is a biocompatible material.

In some embodiments, the stimulation device is configured to operate in at least one of a solo mode, a game mode, a fitness mode, and a social network mode. In some embodiments, the stimulation device is configured to respond to control signals as a function of the mode of operation and vibration parameters received from at least one of a control device and a remote device.

In some embodiments, the main housing further comprises a pairing module configured for pairing the stimulation device with the at least one of a control device and a remote device.

In accordance with another broad aspect, there is provided a communication device. The communication device comprises at least one processor; and a memory, communicatively coupled to the processor. The memory comprises computer-readable instructions for execution by the at least one processor for establishing a first connection wirelessly with a stimulation device; establishing a second connection over a network to at least one remote communication device; receiving, over the network, at least one control signal from the remote communication device; and sending the at least one control signal to the stimulation device for controlling operation of the stimulation device.

In some embodiments, establishing a first connection wirelessly with a stimulation device comprises receiving login credentials; effecting a login based on the login credentials; and transmitting at least one pairing signal to the stimulation device.

In some embodiments, controlling the operation of the stimulation device comprises setting a mode of operation of the stimulation device selected from a group consisting of a solo mode, a game mode, a fitness mode, and a social network mode.

In some embodiments, establishing a second connection to at least one remote communication device comprises: sending, over the network, at least one request for connection; obtaining, over the network, at least one response to the at least one request for connection; selecting the at least one remote device from the at least one response; and establishing the second connection to the at least one remote device.

In some embodiments, the second connection with the at least one remote communication device is established via a social media network.

In some embodiments, the at least one control signal is received from the remote communication device via a central management system.

In some embodiments, the processor is further configured for causing the communication device to send, over the network, at least one of a feedback indicator, a score, and an achievement to the at least one remote device.

In some embodiments, the processor is further configured for causing the communication device to override the at least one control signal received from the at least one remote communication device.

In some embodiments, the processor is further configured for causing the communication device to break the second connection to the at least one remote communication device; and prevent further connections from being established to the at least one remote communication device.

In some embodiments, the stimulation device is a stimulation device according to any one of the embodiments described herein.

In accordance with yet another broad aspect, there is provided a communication device. The communication device comprises at least one processor; and a memory, communicatively coupled to the processor. The memory comprises computer-readable instructions for execution by the at least one processor for receiving, over a network, at least one request for connection to a stimulation device; sending, over the network, a response to the at least one request for connection; establishing a connection to the stimulation device; and sending at least one control signal to the stimulation device for controlling operation of the stimulation device.

In some embodiments, establishing a connection to the stimulation device comprises establishing a first connection to a control device through the network, the control device wirelessly connected to the stimulation device through a second connection.

In some embodiments, the at least one control signal is sent from the communication device to the control device via a central management system.

In some embodiments, receiving, over a network, at least one request for connection further comprises accessing a social media network.

In some embodiments, sending at least one control signal to the stimulation device comprises sending a plurality of control signals sequentially to cause the stimulation device to respond to the control signals in a continuous manner.

In some embodiments, sending a plurality of control signals comprises selecting one of pre-set vibration sequences and user-selected vibration sequences.

In some embodiments, the processor is further configured for receiving, over the network, at least one of a feedback indicator, a score, and an achievement.

In some embodiments, the at least one of a feedback indicator, a score, and an achievement is received concurrently with transmission of a plurality of control signals to operate the stimulation device, in substantially real time.

In some embodiments, the stimulation device is a stimulation device according to any one of the embodiments described herein.

In some embodiments, the communication device communicates with the stimulation device through a control device according to any one of the embodiments described herein.

### BRIEF DESCRIPTION OF THE DRAWINGS

Further features and advantages of the present invention will become apparent from the following detailed description, taken in combination with the appended drawings, in which:

FIG. 1 is an exemplary embodiment of an operating environment for a stimulation device;

FIG. 2A illustrates an exemplary embodiment for the stimulation device;

FIG. 2B is an exploded view of the stimulation device of FIG. 2A;

FIG. 3 is a block diagram of an exemplary embodiment for the stimulation device;

FIG. 4A is an exemplary circuit diagram for a control circuit;

FIG. 4B is an exemplary circuit diagram for a status indicator control circuit;

FIG. 4C is an exemplary circuit diagram for a Bluetooth antenna circuit;

FIG. 4D is an exemplary circuit diagram for a motor control circuit;

FIG. 4E is an exemplary circuit diagram for a battery control circuit;

FIG. 5 is a block diagram of an exemplary embodiment of a control device;

FIG. 6 is a block diagram of an exemplary control application running on a control device;

FIG. 7 is a flowchart of an exemplary method of operating a control device; and

FIG. 8 is a flowchart of an exemplary method of operating a remote device.

It will be noted that throughout the appended drawings, like features are identified by like reference numerals.

### DETAILED DESCRIPTION

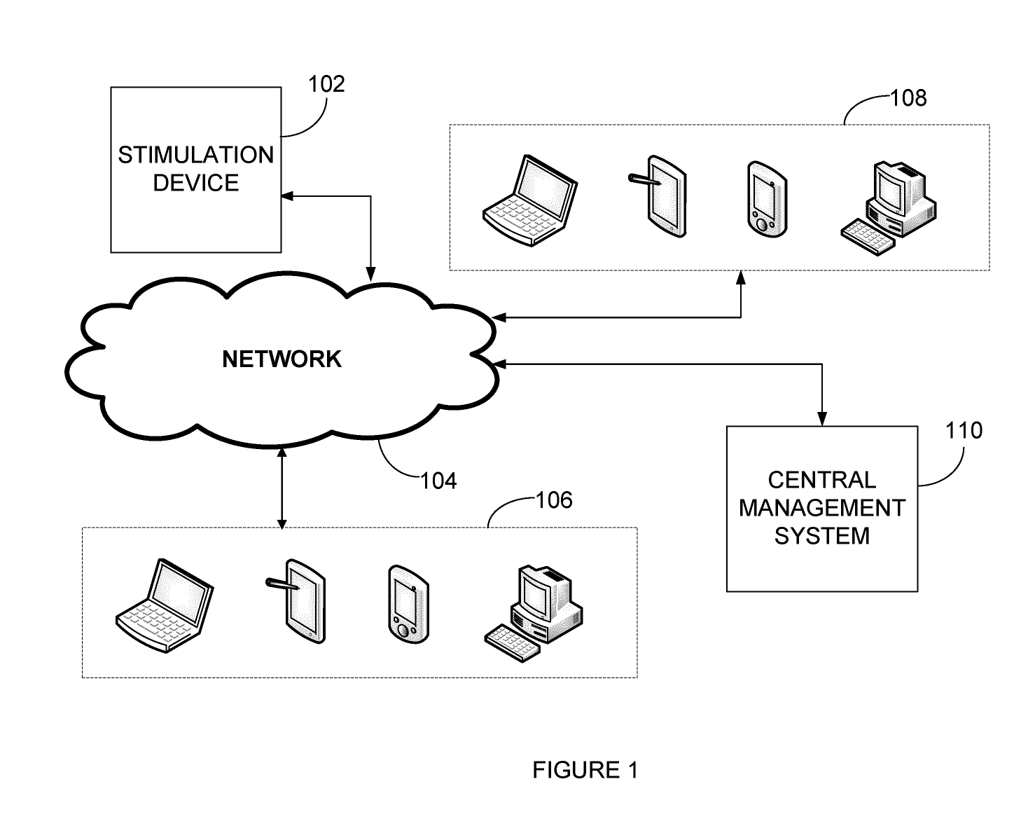

There is described herein a stimulation device and exemplary environment for operation thereof. In FIG. 1, there is illustrated the stimulation device 102 operatively connected to one or more control devices 106 via a network 104. The control devices 106 primarily control the stimulation device 102 via a control application. In some embodiments, remote devices 108 may interact with the stimulation device 102 when the stimulation device 102 is operated in certain operation modes. The interaction may be managed by a central management system 110, as will be explained in more detail below. The network 104 may comprise a plurality of different networks for the different communications. For example, a first network may be provided for communication between the stimulation device 102 and the control devices 106. A second network may be provided for communication between the control devices 106 and the central management system 110. A third network may be provided between the central management system 110 and the remote devices 108. In some embodiments, a first network is provided for communication between the stimulation device 102 and the control devices 106 and a second network is provided for communication between the control devices 106 and the central management system 110 and between the central management system 110 and the remote devices 108.

Various types of networks 104 may be provided for the multiple communications. The network 104 is wireless and may be operated based on RF, infrared, Wi-Fi, Bluetooth, Zigbee, and other technologies. The wireless network 104 may therefore correspond to any one of a wireless personal area network (WPAN), a wireless local area network (WLAN), a wireless mesh network, the Internet, the Public Switch Telephone Network (PSTN), a cellular network, or others known to those skilled in the art. Communication over the network 104 may occur using any known communication protocols that enable devices within a computer network to exchange information. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol). In one exemplary embodiment, the stimulation device 102 and the control devices 106 communicate via Bluetooth while the control devices 106, remote devices 108 and central management system 110 communicate via the Internet or a cellular network.

The control devices 106 may comprise any communication device, such as a personal computer, a tablet, a smart phone, or the like, which is configured to communicate wirelessly over the network 104 with the stimulation device 102. A separate adapter may be connected to the control devices 106 for enabling communication with the stimulation device 102. The control devices 106 may be provided with a driver for connecting to a computer. The stimulation device 102 may be provided with a profile for pairing with the control devices 106. In some embodiments, the control application may be provided directly on one of the control devices 106, either as a downloaded software application, a firmware application, or a combination thereof. In some embodiments, the control application may be web-based and accessed by the control devices 106 via the network 104 using a compatible web browser. In some embodiments, the control application is a combination of a web-based and a local software application.

The remote devices 108 may comprise any device, such as a personal computer, a tablet, a smart phone, or the like, which is configured to communicate wirelessly over the network 104 with the central management system 110 and the control devices 106. The central management system 110, may comprise one or more backend-type servers to host content and information, such as but not limited to user login information, user profile information, chat session data, game session information, and ratings. The server(s) may be of various types, such as an application server, a database server, a communications server, and a Web server. The server(s) may be dedicated servers, cloud servers, or a combination thereof. The server(s) may comprise, amongst other things, a plurality of applications running on a processor coupled to a memory. One or more application programming interface (API) may be provided for accessing backend functions from the control devices 106 and/or the remote devices 108, for security and authentication, and/or for initial setup and installation.

The central management system 110 may communicate with the control devices 106 and the remote devices 108 in a variety of ways. For example, the central management system 110 may communicate via wire-based technology, such as electrical wires or cables, and/or optical fibers. The central management system 110 may also communicate via wireless means, such as RF, infrared, Wi-Fi, Bluetooth, cellular radio, and others. The central management system 110 may also communicate by a combination of wired and wireless means. As such, communication with the server 100 may therefore traverse a network, such as the Internet, the Public Switch Telephone Network (PSTN), a cellular network, or others known to those skilled in the art, or any suitable combination of networks. Communication over one or more of the aforementioned networks may occur using any known communication protocols that enable devices within a computer network to exchange information. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol). The central management system 110 may be accessible to the control devices 106 and the remote devices 108 via any one or more of the aforementioned communication means.

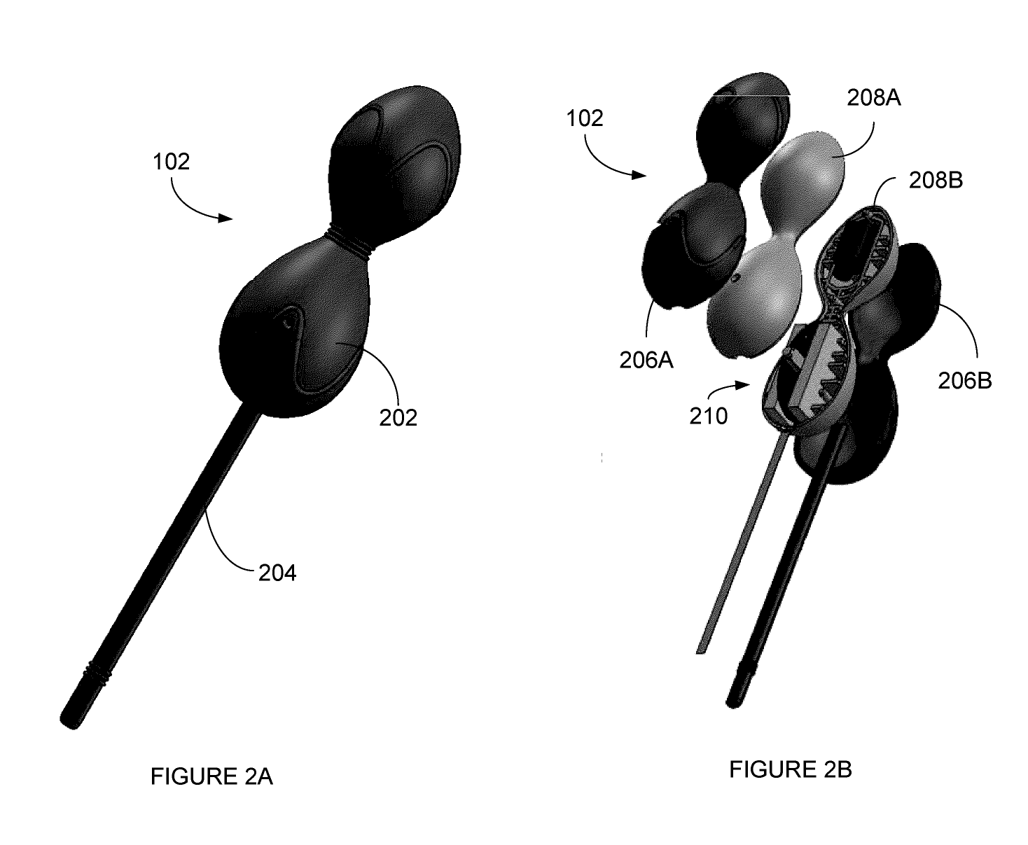

FIG. 2A illustrates an exemplary embodiment for the stimulation device 102. A main housing 202 is shaped to be inserted into a body through an orifice. While the present example illustrates the main housing as shaped like a bowling pin, other shapes may be provided, such as round, conical, banana-shaped, Faberge egg-shaped, etc. A grasping portion 204 extends from an end of the main housing 202 and remains at least partially outside of the body when the main housing 202 is inside the body. The grasping portion 204 has dual purpose. For one, it may be used to remove the stimulation device 102 from inside the body, by manually pulling on the grasping portion 204 to retrieve the device 102. In addition, the grasping portion 204 has an antenna integrated therein. The antenna receives control signals from a control application, as will be explained in more detail below. The grasping portion, and thus the antenna, remain completely or partially outside of the body, as desired by the user, during operation of the stimulation device 102. Providing the antenna on the outside of the body while use of the stimulation device 102 inside the body facilitates reception and transmission of control signals by the antenna.

The antenna may be made from any flexible material, such as paper, textile, and plastics. For example, the antenna may be designed on a flexible printed circuit board (PCB) using electro-textile, paper-based, fluidic, and/or a synthesized flexible substrate. Kapton Polyimide film may also be used. The antenna may be various feed types, such as a flexible aperture coupled antenna, a Planar Inverted-F antenna (PIFA), a planar monopole antenna, a dipole antenna, or a co-planar waveguide (CPW) antenna. The antenna may be fabricated using various fabrication techniques, such as screen printing, chemical etching, flexography, and ink jet printing. In some embodiments, the antenna comprises a coaxial cable with an antenna portion attached at the end of the coaxial cable. The coaxial cable may thus act as a feed line connecting an antenna receiver to the antenna portion. In some embodiments, the antenna comprises a coaxial cable with an exposed end to act as the antenna portion. Other embodiments for the flexible antenna 204 may also be used.

As illustrated in FIG. 2B, the stimulation device 102 may be covered in a molding material 206A, 206B that is biocompatible, such as medical grade silicone. The main housing 202 composed of a front casing 208A and a back casing 208B may be provided to house a plurality of electrical components 210. The antenna may also be covered in the molding material 206A, 206B, without affecting the functioning of the device 102. The covered antenna acts as the grasping portion 204.

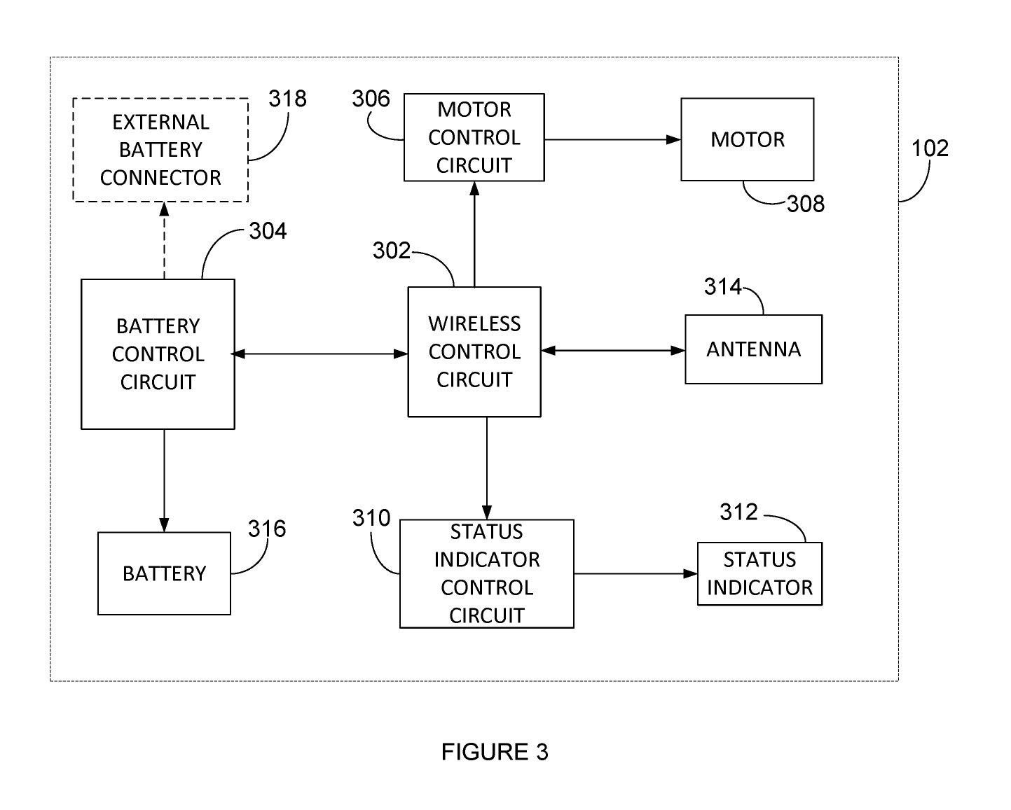

FIG. 3 is an exemplary block diagram of the stimulation device 102. In this example, a wireless control circuit 302 acts as a central hub to a battery control circuit 304, a motor control circuit 306, and a status indicator control circuit 310. The battery control circuit 304 controls a battery 316 that powers the stimulation device 102. The battery 316 may be any type of rechargeable or non-rechargeable battery, such as but not limited to Lithium-Ion, Nickel-Cadmium, Alkaline, and Silver-oxide. The battery 316 may operate at a voltage between 1 V and 5V, or greater than 5 V or less than 1 V. In some embodiments, the battery 316 is a rechargeable Lithium-Ion battery having an operating voltage between 2.75 V and 4.23 V. The battery 316 may be connected to the battery control circuit 304 via a connector (not shown), such as a wire provided on a PCB. In some embodiments, an external battery connector 318 is provided to allow the battery 316 to be recharged.

The motor control circuit 306 controls the motor 308 (or vibration generator), which is used to cause the stimulation device 106 to engage the muscles inside the body orifice through a vibrating motion. The motor 308 may thus be a vibration motor, such as a coreless, an LRA/Iron Core/Coreless, an Iron Core/Coreless, or a brushless DC vibration motor. The motor 308 may comprise various form factors, such as long life brushless, coin, encapsulated, enclosed, pager/ERM (eccentric rotating mass), LRA (linear resonant actuator), and PCB mounted.

The status indicator control circuit 310 is operatively connected to a status indicator 312, such as an LED, for activation and deactivation of the LED 312. The status indicator 312 may be used to indicate a low battery or other failure issue. The status indicator 312 may also be used to show an activation mode or other device features.

The wireless control circuit 302 is also operatively connected to the antenna 314, for receiving control signals from one or more of the control devices 106. Output signals may also be sent through the antenna 314 to the control devices 106. In some embodiments, the wireless control circuit 302 is a Bluetooth Low Energy Integrated Circuit (IC), such as the system-on-chip (SoC) solution manufactured by Texas Instruments under part number CC2541. Other microcontrollers may also be used instead, such as the Intel MC S-51 (8051 or 80051). The wireless control circuit 302 and antenna 314 may be connected via one or more intermediate components (not shown), such as a balun and/or a filter, for impedance matching and/or circuit conversion purposes. In some embodiments, the balun is a 2.45 GHz impedance matched balun-BPF for the chip used in the wireless control circuit 302. In some embodiments, the filter is a capacitor-input filter provided between the balun and the antenna 314 to remove unwanted or undesired frequencies from a signal. Other components may also be provided. For example, a step-down converter may connect the battery control circuit 304 to the wireless control circuit 302. An input mechanism, such as a button or switch, may be interfaced with the wireless control circuit 302 to turn the stimulation device 102 on and off.

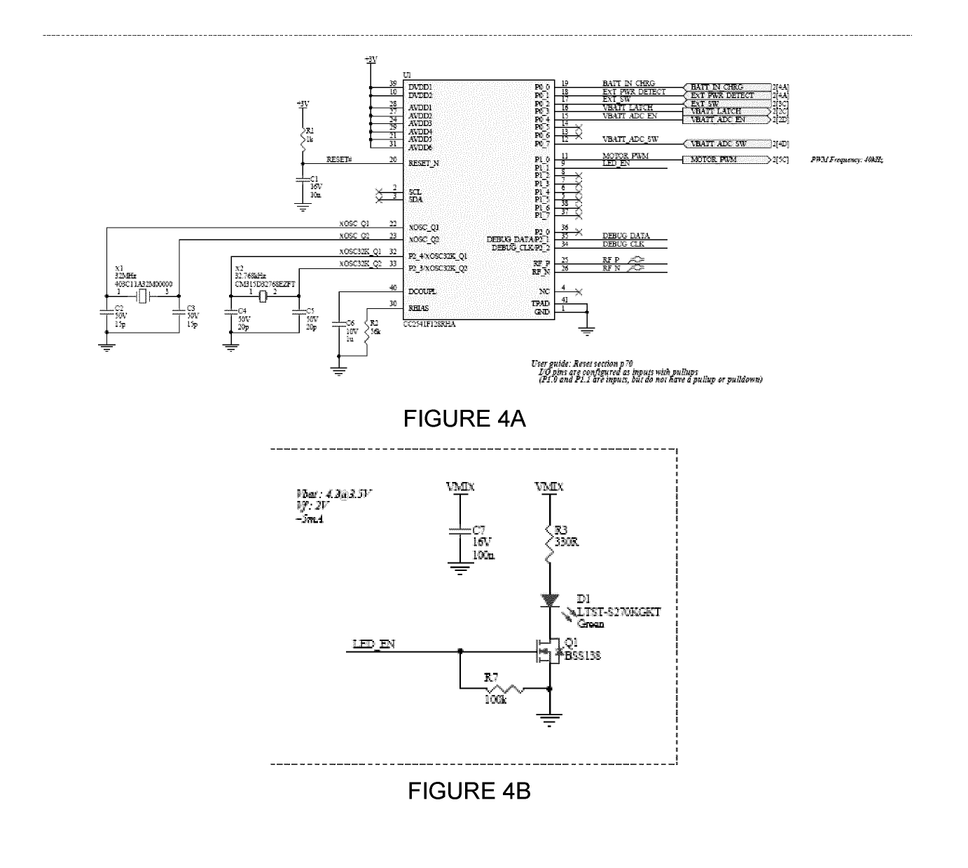

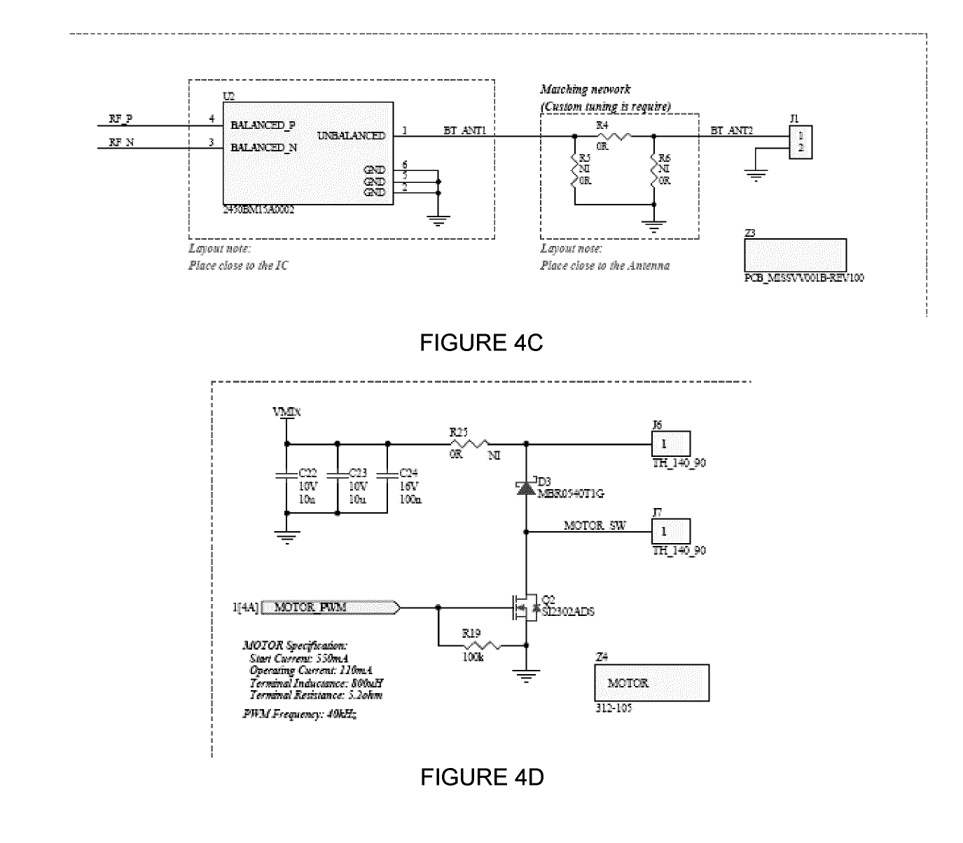

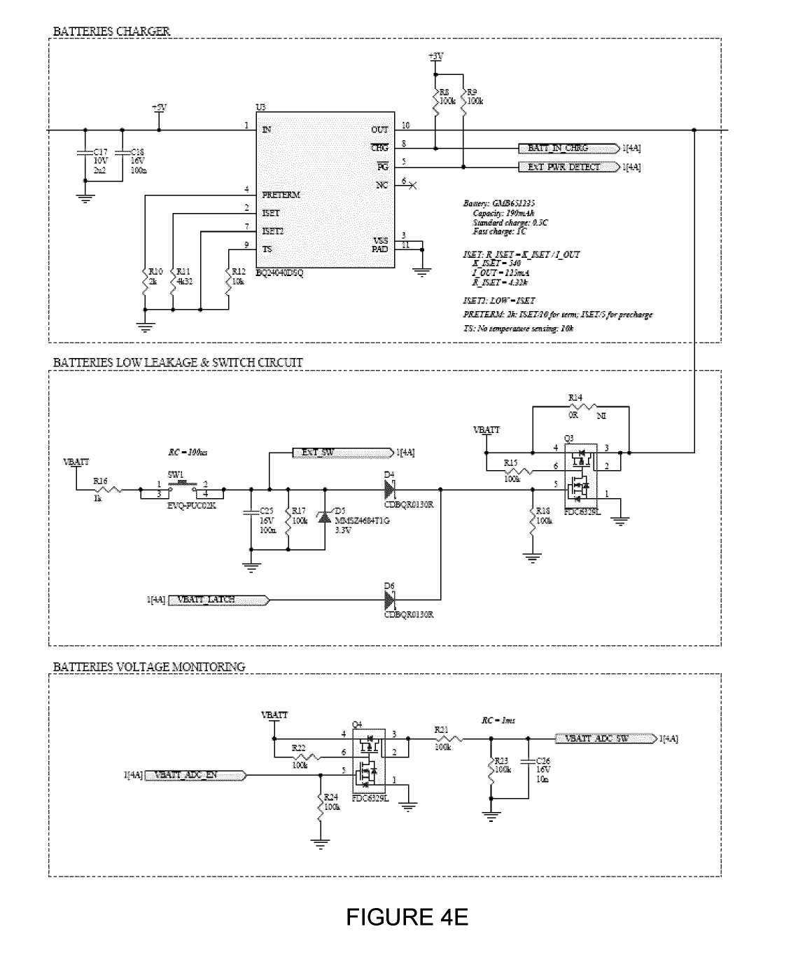

The embodiment of FIG. 3 is illustrative only and the stimulation device 102 may take other forms. For example, a single control circuit may be used to control the battery 316, the motor 308, and a wireless transceiver (transmitter, receiver, or a combination thereof) operatively connected to the antenna 314. FIG. 4A is an exemplary circuit diagram, based on a microcontroller, for a control circuit. FIG. 4B is an exemplary circuit diagram for a status indicator control circuit 310. FIG. 4C is an exemplary circuit diagram for a blue tooth antenna circuit. The control circuit and the antenna circuit may be provided on a same PCB or on separate PCBs. FIG. 4D is an exemplary circuit diagram for a motor control circuit 306. FIG. 4E is an exemplary circuit diagram for a battery control circuit 304.

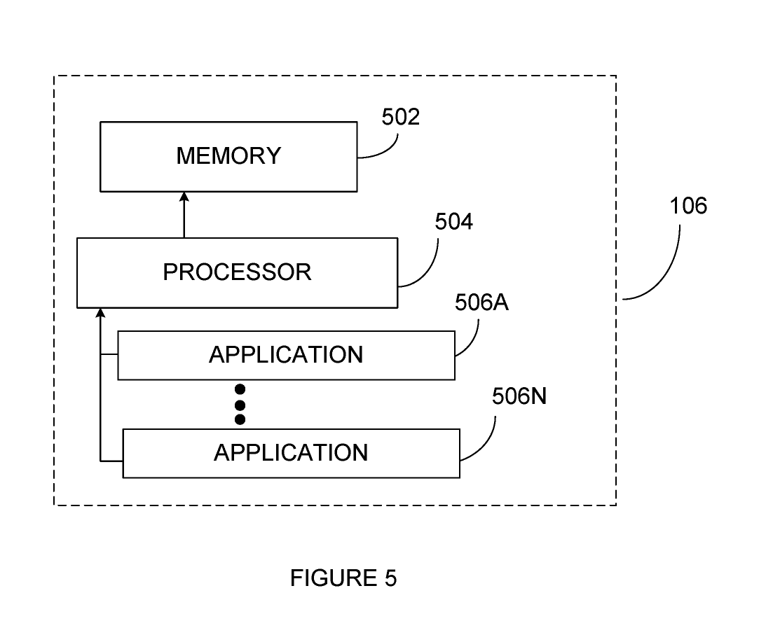

FIG. 5 is an exemplary embodiment of a control device 106. As shown, the control device 106 illustratively comprises one or more applications 506A . . . 506N running on a processor 504 coupled to a memory 502. It should be understood that while the applications 506A . . . 506N presented herein are illustrated and described as separate entities, they may be combined or separated in a variety of ways. The memory 502 is communicatively coupled to and accessible by the processor 504, and may receive and store data. The memory 502 may be a main memory, such as a high speed Random Access Memory (RAM), or an auxiliary storage unit, such as a hard disk, a floppy disk, or a magnetic tape drive. The memory 502 may be any other type of memory, such as a Read-Only Memory (ROM), or optical storage media such as a videodisc and a compact disc. The processor 504 may access the memory 502 to retrieve data. The processor 504 may be any device that can perform operations on data. Examples are a central processing unit (CPU), a front-end processor, a microprocessor, and a network processor; in some embodiments, the processor 504 may be at least one processor. The applications 506A . . . 506N are coupled to the processor 504 and configured to perform various tasks. Outputs may be transmitted to the stimulation device 102 and/or to the remote devices 108.

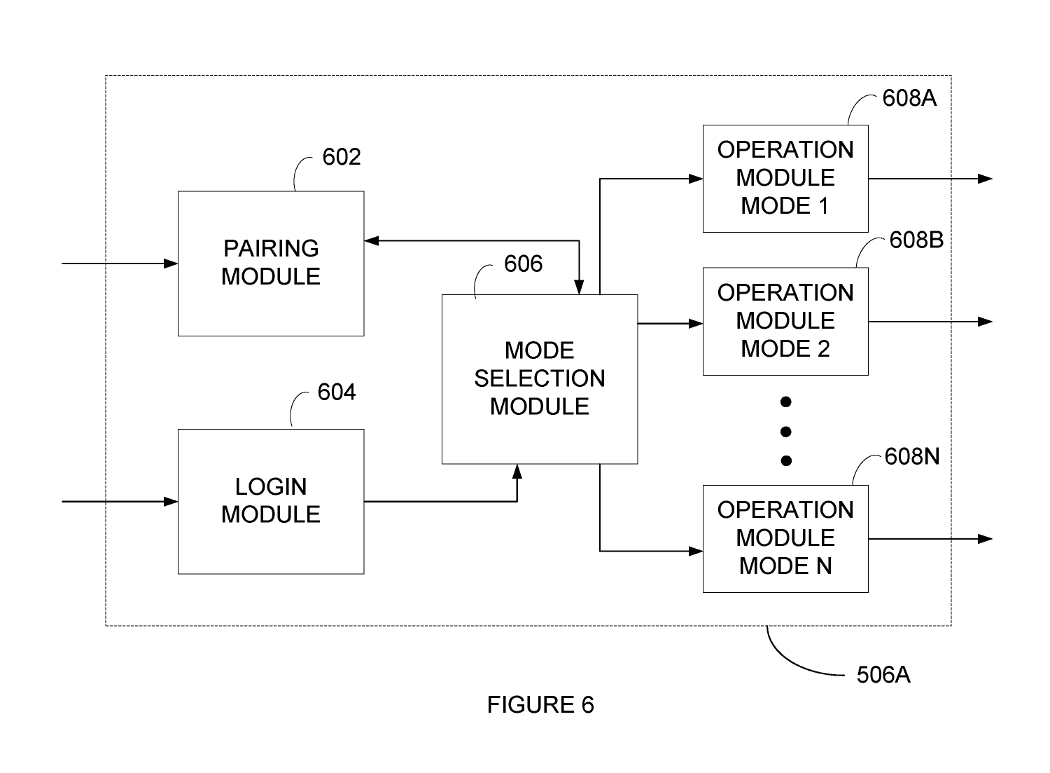

FIG. 6 is an exemplary embodiment of an application 506A running on the processor 504. The application 506A illustratively comprises a pairing module 602, a login module 604, a mode selection module 606, and a plurality of operation modules 608A, 608B, 608N. The pairing module 602 is configured to pair the control device 106 with the stimulation device 102 using any known pairing or identification method, including single-sided or double-sided handshaking protocols, ad-hoc pairing protocols, and the like. The login module 604 is configured for allowing a user to login to an account using a username and password and/or to create an account. Once logged in, a mode selection module 606 may be configured to provide the user with a plurality of operating modes. For example, the mode selection module 606 may offer a solo mode, a game mode, a fitness mode, and a social network mode. Each mode may offer one or more sub-categories. For example, the solo mode may offer a set of predetermined stimulation sequences or it may offer “freestyle” operation. In some embodiments, pairing is performed via the mode selection module 608, which activates the pairing module 602 when the proper mode is selected. Once a mode is selected, a corresponding operation module 608A, 608B, 608N, is used to operate the stimulation device 102.

At least one of the operation modules 608A, 608B, 608N is configured to allow the control device 106 to send control signals to the stimulation device 102, i.e. solo mode. Various preset vibration modes may be provided for solo mode and selected by a user on the control device 106. Basic vibration speeds and/or intensities may also be offered, for selection in a freestyle mode of operation, where various vibration parameters may be manually set via the control device 106.

In some embodiments, the application 506A may also be used on the remote devices 108, and one of the options presented by the mode selection module 606 is to play in remote mode. One of the operation modules 608A, 608B, 608N may thus be configured for remote play, whereby control signals for the stimulation device 102 are generated by a remote device 108, sent to a control device 106, and then sent to the stimulation device 102. In some embodiments, the control device 106 may, at any time, override any control signals sent by the remote device 108 for control of the stimulation device 102.

In some embodiments, remote mode may be selected from the control device 106. An operation module 608A, 608B, 608N may be configured for selection of a partner. Selection of the partner may occur via a social network, such as Facebook™ or Tinder™, or a custom-designed social network for users of the stimulation device 102, as is discussed in greater detail hereinbelow. Selection of the partner may also occur in a gaming environment, whereby participants are represented by characters in the game. In some embodiments, the characters are represented by avatars. Various features typically offered by social networks and/or gaming environments, such as messaging, ratings, profiles, etc, may be provided by the operation modules 608A, 608B, 608N.

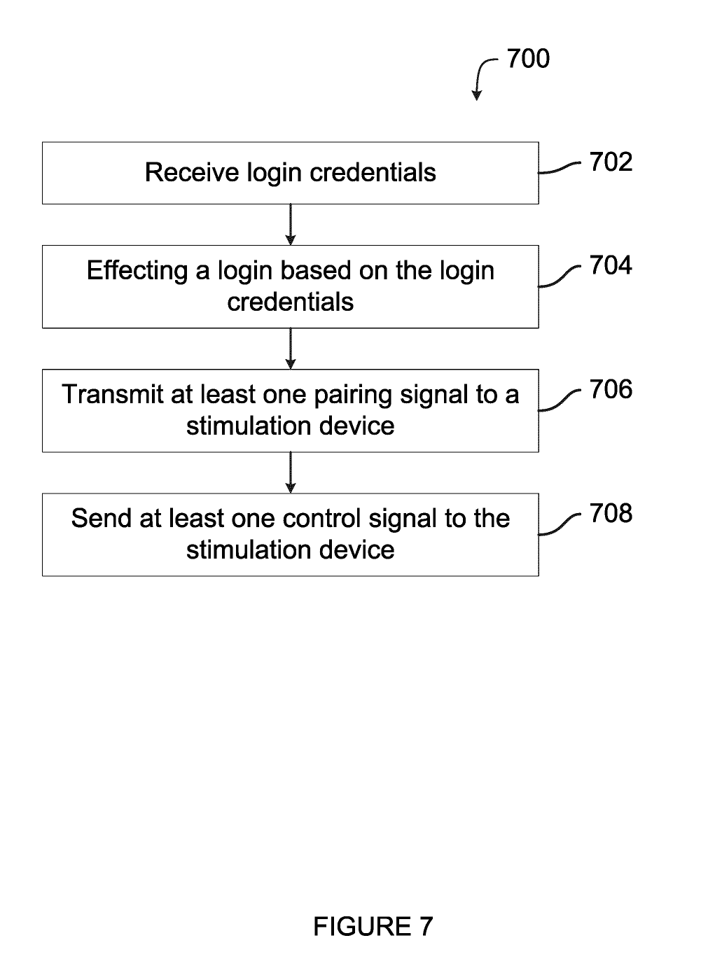

With reference to FIG. 7, any of the control devices 106 may implement a method 700 for interacting with the stimulation device 102. At a first step 702, the control device 106 may receive login credentials from the user of the control device 106, which may include a username or email address, and a password. In cases where no login credentials have been provided to the user, the control device 106 may register the user by requesting a username or email address and a password, as well as any other suitable information, from the user of the control device 106.

At step 704, the control device 106 may effect a login of the user based on the login credentials. This may include validating the credentials against known credentials present in a database, or by validating a checksum of the login credentials, or by any other suitable means, and may involve the control device 106 contacting the central management system 110. If the credentials are invalid, the method 700 may return to step 702. Once validated, the control device 106 may acquire information about the user, including profile information, preferences, and the like, for example from the central management system 110.

At step 706, the control device 106 may transmit at least one pairing signal to the stimulation device 102 to cause the control device 106 to communicatively pair with the stimulation device 102.

At step 708, the control device 106 may send at least one control signal to the stimulation device 102, for controlling the operation of the stimulation device 102. The stimulation device 102 may be configured for operating in at least one operating mode; alternatively, or in addition, the operation of the stimulation device 102 may also be based on preferences of the user of the stimulation device 102.

In embodiments where the control device 106 allows for remote play from the remote device 108, the method 700 may comprise additional steps not illustrated in FIG. 7: this may include the control device 106 establishing a connection to the remote device 108 over a network, receiving at least one control signal from the remote device 108 over the network, and then sending the at least one control signal received from the remote device 108 to the stimulation device 102. The control signals received by the control device 106 may be sent from the remote device 108 via the central management system 110. In some embodiments, the control device 106 may be configured for sending control signals to the stimulation device 102 which originate from both the control device 106 and the remote device 108; in other embodiments, the control device 106 may only pass on to the stimulation device 102 control signals which originate from the remote device 108. As with the control device 106, the remote device 108 may be configured for causing the stimulation device 102 to operate in one of a plurality of modes, or may allow a user to operate in a freestyle mode.

In order to connect to the remote device 108, the control device 106 may send a request over a network for a list of at least one potential remote device 108. The request may be routed through any suitable network, such as the central management system 110. The potential remote device 108 may be any suitable one of the remote devices 108 which is available to act as remote device 108 for sending control signals to the stimulation device 102.

In some embodiments, the list of at least one potential remote device 108 may be obtained via a social media network. For example, a custom social media network may exist for facilitating the matching of users of control devices 106 with users of remote devices 108, and may be implemented by the central management system 110. A given user may register on the custom social media network and provide at least some user information, including whether the given user is a user of a control device 106, a user of a remote device 108, or whether the user wishes to use both a control device 106 and a remote device 108 at different times or in different situations.

The control device 106 may then be configured for sending a request for a partner, which may appear as a post or event on the custom social media network. The post or event may be visible to other users of the custom social media network, including to a user of the remote device 108. If the user is interested in acting as a partner, the remote device 108 may send a request to act as a partner via the custom social media network, which may then be received by the control device 106. Alternatively, or in addition, once the control device 106 has sent the request for a partner, the control device 106 may receive a listing of all remote devices 108 which are available or suitable to act as a partner. The control device 106 may present a listing of available or suitable partners, or of remote devices 108 which have requested to act as a partner, and the control device 106 may then receive from the user of the control device 106 an indication of at least one selected remote device 108. Once a partner (or multiple partners) has been selected, the control device 106 may establish a connection with the at least one selected remote device 108 via the custom social media network. To facilitate the foregoing requests and exchanges, each control device 106 and remote device 108 may be assigned an identifier, which may be related to the login credentials of the users, and interactions between the control devices 106 and remote devices 108 via the custom social media network may each include the identifier.

Once the control device 106 and the remote device 108 are connected, the control device 106 and the remote device 108 may be configured for sharing content, such as messages, voice conversations, images, videos, and the like, via the custom social media network. The messages may be textual messages, audio messages, video messages, and the like, and may include emoji, stickers, or any other suitable communications. The custom social media network may include an encryption protocol for preventing unauthorized devices from accessing the shared content, and may additionally, or alternatively, include various privacy settings for controlling access to content generated by the control device 106 and/or the remote device 108.

Additionally, the control device 106 may be configured to send results or feedback to the remote device 108 regarding the interaction between the user of the remote device 108 and the user of the control device 106 via the custom social media network. This may include feedback messages, which may be preset or composed by the user of the control device 106, a score, one or more achievements or trophies, or any other suitable result. These results may be presented on the custom social media network in any suitable fashion: for example, a user's average score may be presented on a scale of 1 to 10, on a five-star scale, and the like; trophies or achievements acquired by a user of remote device 108 may be presented in a virtual trophy case or achievement hall on the custom social media network.

The control device 106 may also be configured for overriding or blocking the remote device 108 from sending control signals to the stimulation device 102. For instance, the control device 106 may be configured for overriding a control signal received from the remote device 108, such that the stimulation device 102 operates in accordance with the control signal received from the control device 106 and not in accordance with the control signal received from the remote devices 108. Similarly, the control device 106 may be configured for blocking at least one remote device 108: this may include the control device 106 first severing or breaking the connection established between the control device 106 and the at least one remote device 108, and may further include the control device 106 preventing further connections from being established between the control device 106 and the at least one remote device 108. Blocking at least one remote device 108 may be effected at the control device 106, or may be effected via the custom social media network.

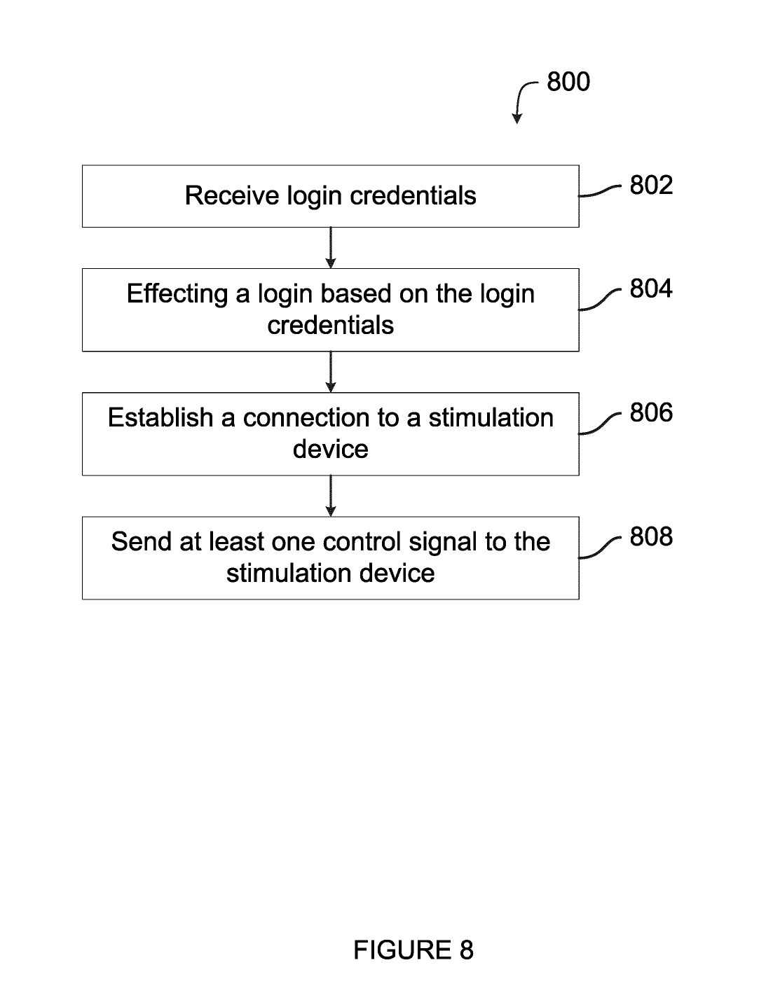

With reference to FIG. 8, the remote device 108 may implement a method 800 for sending control signals to the stimulation device 102. At step 802, the remote device 108 may receive login credentials from the user of the remote device 108, which may include a username or email address, and a password. In cases where no login credentials have been provided to the user, the control device may register the user by requesting a username or email address and a password, as well as any other suitable information, from the user of the remote device 108.

At step 804, the remote device 108 may effect a login of the user based on the login credentials, which may be implemented as described hereinabove in relation to step 704. At step 806, the remote device 108 may establish a connection to the stimulation device 102. This connection may be established through the control device 106, and possibly through central management system 110, or may be established directly with the stimulation device 102. In the latter case, the pairing process may be effected by the remote device 108 pairing directly with the stimulation device 102 in similar fashion as is described supra, or the pairing process may be facilitated or mediated by the control device 106. In some embodiments, the control device 106 may be configured to forcibly unpair the remote device 108 and the stimulation device 102.

Establishing the connection between the remote device 108 and the stimulation device 102 may be facilitated by the custom social media network, as discussed supra. Specifically, the remote device 108 may provide an indication of an availability of the remote device 108 to act as a partner for at least one control device 106, and following a selection of the remote device 108, the connection between the remote device 108 and the stimulation device 102, via the control device 106 or directly, may be established.

At step 808, the remote device 108 may send at least one control signal to the stimulation device 102. Depending on the nature of the connection between the remote device 108 and the stimulation device 102, the control signal may be sent in different ways, including via the control device 106, optionally via the central management system 110, or to the stimulation device 102 without passing through the control device 106.

The above description is meant to be exemplary only, and one skilled in the relevant arts will recognize that changes may be made to the embodiments described without departing from the scope of the invention disclosed. For example, the blocks and/or operations in the flowcharts and drawings described herein are for purposes of example only. There may be many variations to these blocks and/or operations without departing from the teachings of the present disclosure. For instance, the blocks may be performed in a differing order, or blocks may be added, deleted, or modified. While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment. The present disclosure may be embodied in other specific forms without departing from the subject matter of the claims. Also, one skilled in the relevant arts will appreciate that while the systems, methods and computer readable mediums disclosed and shown herein may comprise a specific number of elements/components, the systems, methods and computer readable mediums may be modified to include additional or fewer of such elements/components. The present disclosure is also intended to cover and embrace all suitable changes in technology. Modifications which fall within the scope of the present invention will be apparent to those skilled in the art, in light of a review of this disclosure, and such modifications are intended to fall within the appended claims.

1. A stimulation device comprising:
a main housing comprising a vibration generator, a battery, a wireless transceiver, and at least one control circuit operatively connected to the vibration generator, the battery, and the wireless transceiver, the main housing shaped for entering a body orifice; and
a flexible antenna extending from the main housing at a bottom end thereof for remaining at least partially outside the body when the main housing is inside the body, the flexible antenna operatively connected to the wireless transceiver for receiving control signals for controlling operation of the vibration generator.

2. The stimulation device of claim 1, wherein the main housing is shaped like a bowling pin or a pair of conjoined Faberge eggs.

3. (canceled)

4. The stimulation device of claim 1, wherein the antenna is covered by a molding material.

5. The stimulation device of claim 4, wherein the main housing is covered by the molding material.

6. The stimulation device of claim 5, wherein the molding material is a biocompatible material.

7. The stimulation device of claim 1, wherein the stimulation device is configured to operate in at least one of a solo mode, a game mode, a fitness mode, and a social network mode.

8. The stimulation device of claim 7, wherein the stimulation device is configured to respond to control signals as a function of the mode of operation and vibration parameters received from at least one of a control device and a remote device.

9. The stimulation device of claim 8, wherein the main housing further comprises a pairing module configured for pairing the stimulation device with the at least one of a control device and a remote device.

10. A communication device, comprising:
at least one processor; and
a memory, communicatively coupled to the processor and comprising computer-readable instructions for execution by the at least one processor for:
establishing a first connection wirelessly with a stimulation device;
establishing a second connection over a network to at least one remote communication device;
receiving, over the network, at least one control signal from the remote communication device; and
sending the at least one control signal to the stimulation device for controlling operation of the stimulation device.

11. The communication device of claim 10, wherein establishing a first connection wirelessly with a stimulation device comprises:
receiving login credentials;
effecting a login based on the login credentials; and
transmitting at least one pairing signal to the stimulation device.

12. The communication device of claim 10, wherein controlling the operation of the stimulation device comprises setting a mode of operation of the stimulation device selected from a group consisting of a solo mode, a game mode, a fitness mode, and a social network mode.

13. The communication device of claim 10, wherein establishing a second connection to at least one remote communication device comprises:
sending, over the network, at least one request for connection;
obtaining, over the network, at least one response to the at least one request for connection;
selecting the at least one remote device from the at least one response; and
establishing the second connection to the at least one remote device.

14. The communication device of claim 10, wherein the second connection with the at least one remote communication device is established via a social media network.

15. The communication device of claim, wherein the at least one control signal is received from the remote communication device via a central management system.

16. The communication device of claim 10, wherein the processor is further configured for causing the communication device to send, over the network, at least one of a feedback indicator, a score, and an achievement to the at least one remote device.

17. The communication device of claim 10, wherein the processor is further configured for causing the communication device to override the at least one control signal received from the at least one remote communication device.

18. The communication device of claim 10, wherein the processor is further configured for causing the communication device to:
break the second connection to the at least one remote communication device; and
prevent further connections from being established to the at least one remote communication device.

19. (canceled)

20. A communication device, comprising:
at least one processor; and
a memory, communicatively coupled to the processor and comprising computer-readable instructions for execution by the at least one processor for:
receiving, over a network, at least one request for connection to a stimulation device;
sending, over the network, a response to the at least one request for connection;
establishing a connection to the stimulation device; and
sending at least one control signal to the stimulation device for controlling operation of the stimulation device.

21. The communication device of claim 20, wherein establishing a connection to the stimulation device comprises establishing a first connection to a control device through the network, the control device wirelessly connected to the stimulation device through a second connection.

22. The communication device of claim 21, wherein the at least one control signal is sent from the communication device to the control device via a central management system.

23. The communication device of claim 20, wherein receiving, over a network, at least one request for connection further comprises accessing a social media network.

24. The communication device of claim 20, wherein sending at least one control signal to the stimulation device comprises sending a plurality of control signals sequentially to cause the stimulation device to respond to the control signals in a continuous manner.

25. The communication device of claim 24, wherein sending a plurality of control signals comprises selecting one of pre-set vibration sequences and user-selected vibration sequences.

26. The communication device of claim 20, wherein the processor is further configured for receiving, over the network, at least one of a feedback indicator, a score, and an achievement.

27. The communication device of claim 26, wherein the at least one of a feedback indicator, a score, and an achievement is received concurrently with transmission of a plurality of control signals to operate the stimulation device, in substantially real time.

28. (canceled)

29. (canceled)
